(19) United States
(12) Patent Application Publication
(10) Pub. No.: US 2008/0071613 A1
(43) Pub. Date: Mar. 20, 2008

(54) METHOD OF OFFERING INCENTIVES TO USERS OF INTERNET SERVICES

(75) Inventor: David Eppert, Delta (CA)

Correspondence Address: VERMETTE & CO., SUITE 320 - 1177 WEST HASTINGS STREET, VANCOUVER, BC, V6E2K3, US

(73) Assignee: MY GUIDE INC., West Vancouver (CA)

(21) Appl. No.: 11/532,870

(22) Filed: Sep. 18, 2006

(51) Int. Cl. G06Q 30/00

(52) U.S. Cl. 705/14

(57) ABSTRACT

A method of providing incentives to users of a search engine at a website, including registering each user, sending a confirmation email to each user at each user's current email address, providing a login facility for each user, providing a search engine for each user, providing a user logout; and incrementing user points each time any of the foregoing steps are used. The points can be redeemed for cash, merchandise or services.

### FIELD

The present invention relates to a method of offering monetary, merchandise and services incentives to users of internet services

### BACKGROUND

Standard search engines receive revenue from direct advertising and affiliate programs such as pay per click search results. Search engine owners are motivated to attract as many users as possible in order to make their site as interesting as possible to advertisers and affiliates and, therefore, to maximize their revenue. Presently, users are given no other incentives to use a search engine other than the ability to conduct searches. This situation makes it very difficult for a new search engine to compete against large established ones such as Google. One technique available to businesses operating with a website is to attempt to use certain key words and phrases in order to be given a high ranking in a listing of search results. Thus, the ranking of a given website in a search engine search result listing depends on the phrases or key words chosen to define the business. This ranking changes as new businesses are created and so the ranking must be monitored and modified from time to time. It would be desirable to have an alternative method of not only attracting users to an advertiser's website but to induce those users to use the website in as many ways as possible.

### SUMMARY OF THE INVENTION

A method of providing incentives to users of a search engine at a website, including registering each user, providing a login facility for each user, providing a search engine for each user, providing a user logout; and incrementing user points each time any of the foregoing facilities and methods are used. The points can be redeemed for cash, merchandise or services.

The method may include providing an email system for each user and incrementing user points when the email system is used.

A file storage and file sharing system may be provided for each user and points incremented when the file storage and file sharing system is used by each user.

Advantageously, accumulated user points can be exchanged for cash, merchandise or services. Additionally, a user can earn stock in a company operating the website after reaching a predetermined point accumulation.

The company may redeem user purchased stock using the company's own points

### BRIEF DESCRIPTION OF THE DRAWINGS

Further features and advantages will be apparent from the following detailed description, given by way of example, of a preferred embodiment taken in conjunction with the accompanying drawings, wherein:

FIG. 1 is a flow diagram of an overview of the system;

FIG. 2 is a flow diagram of the Email services;

FIG. 3 is a flow diagram of the file storage and file sharing services;

FIG. 4 is a flow diagram of the search engine operation at a high level;

FIG. 5 is a flow diagram for purchasing advertising.

FIG. 6 is a flow diagram for registration of charitable organization and for adding a specific charity to a users charity group; and

FIG. 7 is a flow diagram for user registration.

### DETAILED DESCRIPTION WITH REFERENCE TO THE DRAWINGS

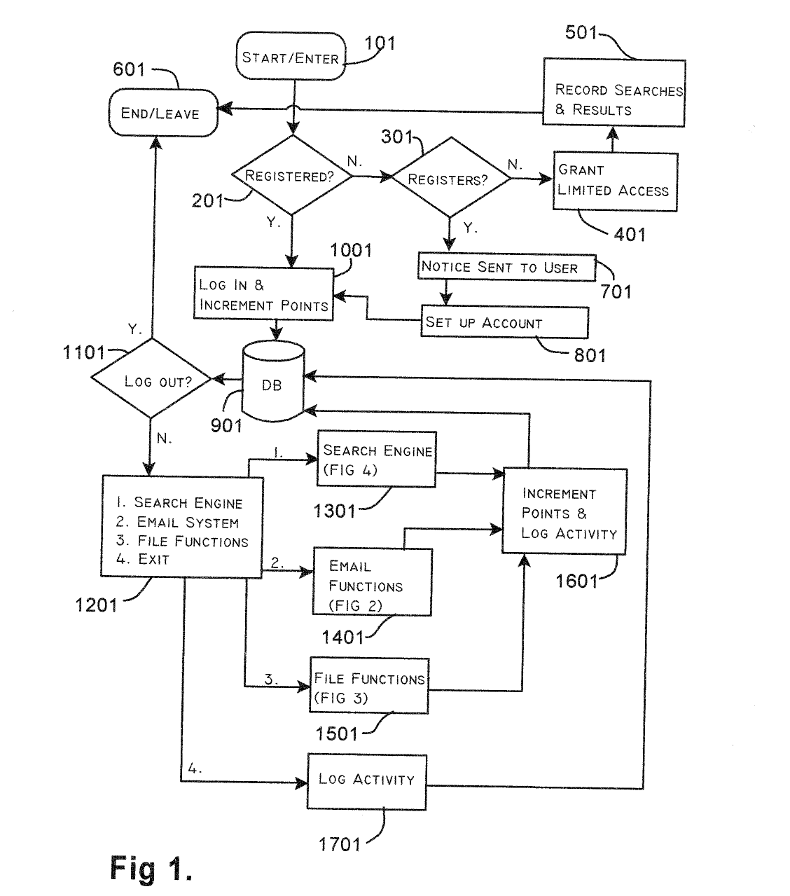

A user incentive program for search engine users is based on the ability to earn points for most actions such users perform within the search engine web site. The method involves user registration using a current Email address and the performance of various actions such as a such as a user login, use of the search engine, use of the Email System and use of the file storage and sharing system in order to gain points. Referring to FIG. 1 a user visits the present website, referred to myGuide.com at 10. The user is queried at 12 as to whether or not he/she wishes to register. If not, then the user is directed to 16 where that user is invited to proceed with a free search and to partake of other free services. The searches are recorded at 18 for analysis. If the user requests registration, then the registration information is stored in a data base at 14. At 20 confirmation of a user's registration is sent to his/her current email address. At 22 a user is invited to click to activate his/her account and go the myGuide.com to login. If the user agrees then he/she goes to 24 where he/she logs in. At 26 the action is logged with the time, date and IP address. At 28 the user's points are incremented and then the user is directed to 30 where he/she uses the search engine. Again the action is logged at 32 and the user's points incremented at 34. At 36 the user uses the Email System and again such action is logged with the time, date and IP address recorded. User points are incremented at 40 and the user directed to the file storage and file sharing system at 42. If the user uses the file storage and file sharing system, the action is logged at 44 and user points incremented at 46. The user is then directed to the logout function at 48. If the user chooses not to logout then he/she is directed to 54 where no points are awarded. If the user chooses to logout, then the action is logged at 50 along with the time, date and IP address. Points are incremented at 52. After each incrementing of user points the information is stored in a database at 14.

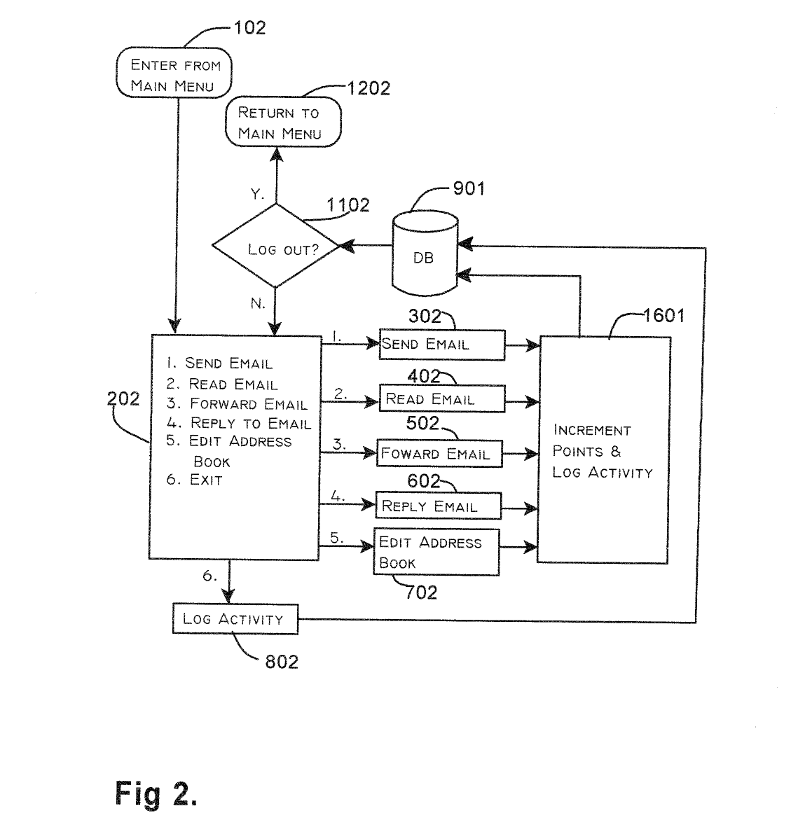

Referring to FIG. 2 the Email services are accessed from 60 where a user logs in. Once logged in the user sends new email at 62 and at 64 the action is logged with time, date, IP Address and Details. At 66 the points are incremented for every email address the user sends to and the resultant increases in points are stored in database 68. The user reads a received email at 70. The action is logged with time, date, IP Address and Details at 72 and at 74 the User's points are incremented. At 76 the User forwards an email with the action being logged at 78 with time, Date, IP Address and Details. At 80 the User's points are incremented and stored in database 68. At 82 the user replies to an email and the action is logged at 84 with time, date, IP Address and Details. At 86 the User's points are incremented and the result stored in database 68. The user adds a contact to his/her address book at 88 resulting in the action being logged with time, date, IP Address and Details. At 92 the User's points are incremented and the result stored in database 68. At 94 the User is asked if he/she wishes to log out. If not, then no points are awarded at 100 and the session times out at 102. If yes, then the action is logged with time, date, IP Address and details. The User's points are incremented at 98 and at 68 those points and the logging information is stored in a database.

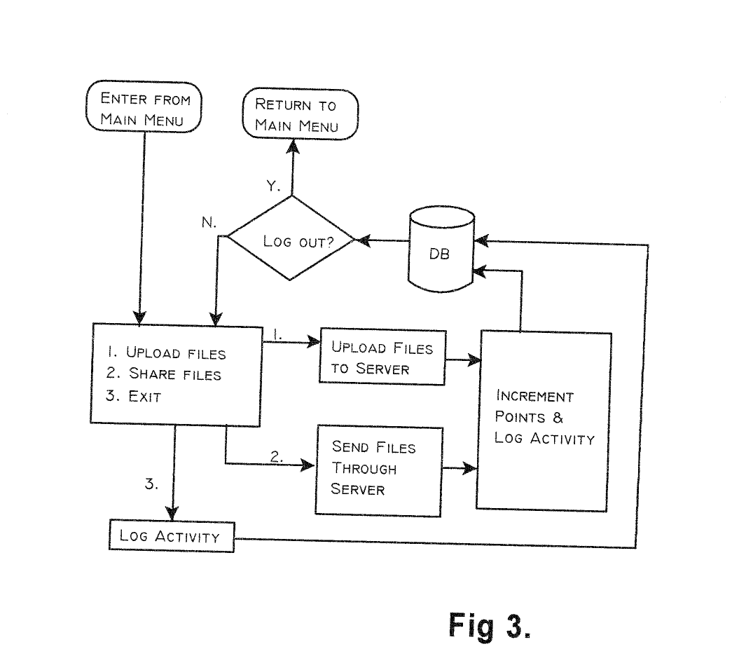

File storage and file sharing services are provided in accordance with FIG. 3 in which a User logs in at 104 and at 106 uploads a file to myGuide.com. The action is logged with time, date, IP Address and details at 108 and at 110 points are incremented for every email address the user sends to. The login information and the points incremented are stored in database 68. At 118 a user shares a file with another user. The action is logged with time, date, IP Address and details at 114 and user points are incremented for every user the file is shared with at 116. The logged information and the points increase is stored in database 68. At 118 a user is invited to logout. If this request is declined, no points are awarded at 124 and the action is not logged at 126. If the user logs out, the action is logged with time, date, IP Address and details at 120 and points incremented at 122. The logout information and points increase is stored in database 68.

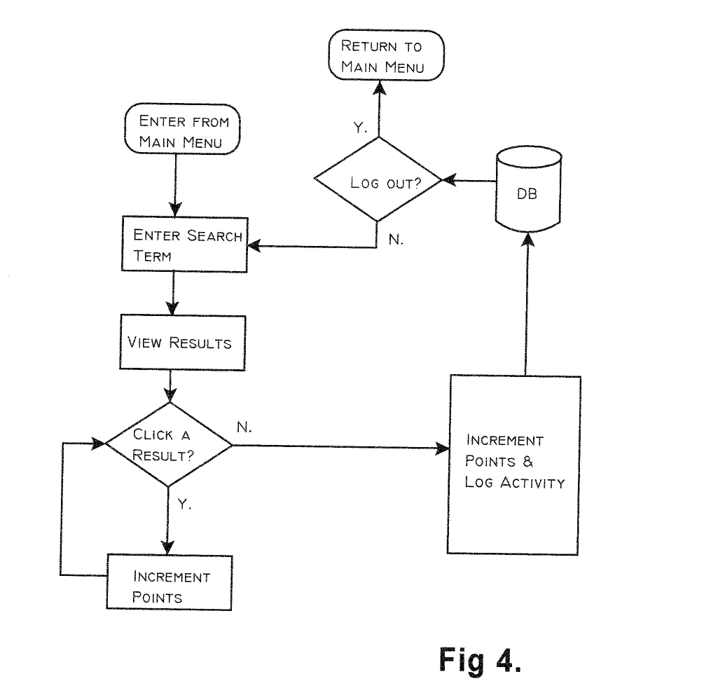

The search engine high level of operation and points awards is shown in FIG. 4. At 130 the User logs in to the myGuide.com website. Points are awarded at 132 and, as before, at 134 the action is logged with time, date, IP Address and details. The points and logged information are stored in database 68. At 136 the user uses the search engine to search for keyword “Cars” and at 138 the user points are incremented. At 140, the action is logged with time, date, IP Address, and details. The latter information is stored in database 68. At 142 the user is presented with a list of search results and clicks on one of the resultant links. Points are awarded at 144 and the action is logged with time, date, IP Address and details. The logged information and the points increment are stored in database 68. Further incentives to a user in the form of Integrated Monetary Incentive Programs allow a user to exchange his/her points for cash or merchandise, depending upon the program being offered at the time.

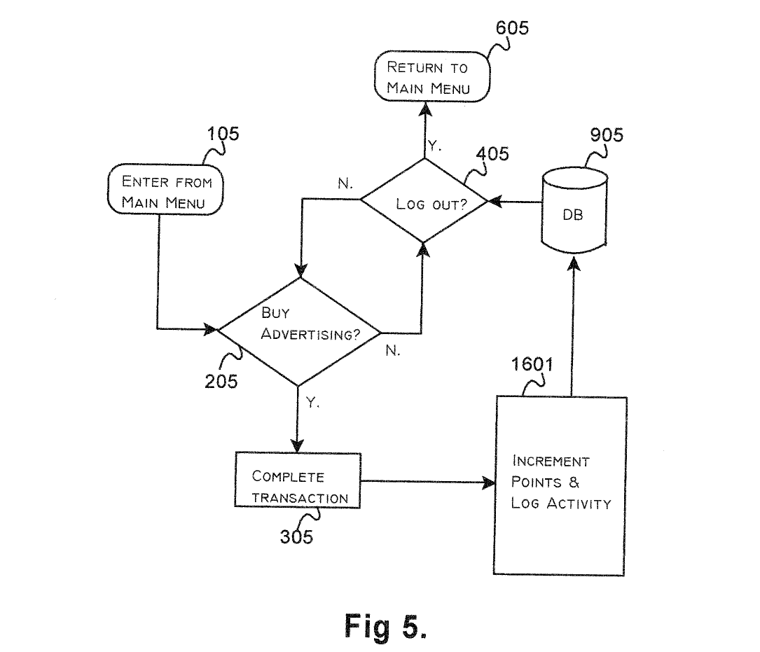

In a standard pay per click search engine, advertisers are able to direct their advertising dollars to qualified target prospects in top positions within the search engine results for specific keyword or key-phrase searches. The present system offers further incentives to advertisers by allowing the user to build myGuide points for each advertising dollar they spend. The points can be redeemed in a number of ways including cash or merchandise depending on the program offered at any given time. Referring to FIG. 5, at 150 a user logs in at myGuide.com. Points are incremented at 152 and the action is logged with time, date and IP Address and details at 154. The points increment and the logged in information are stored in database 68. At 156 the user purchases advertising to the search engine and at 158 user points are incremented. At 160 the action is logged with time, date, IP Address and details and at 68 the logged in information and the points increment are stored in a database. At 162 the user is invited to logout. If the user logs out then at 164 the user's points are incremented and at 166 the action is logged with time, date, IP Address and details and then both of the foregoing are stored in a database at 68.

When a user visits the myGuide website, they have the ability to earn points for most actions they perform within the site. As indicated in the various drawings, points are earned for almost all activities by a user within the myGuide.com sites. These points can be redeemed either within or through the myGuide website for cash, merchandise or services depending on the promotion being offered at the time. Other promotions can be offered during peak and non-peak hours designed to increase peak and non-peak user traffic to the site by implementing various types of promotions which include cash, merchandise, or services or a combination of the latter. Examples of promotions are the following:

(a) A first promotion could give away a $500 cash point redemption offer to the 1000^{th}, 2000^{th}, and 3000^{th} person clicking on the promotion link.

(b) A second promotion could give 500 bonus points to the 1000^{th} person to login on Wednesday.

(c) A third promotion could give a digital camera for redemption of only 200 points to the 200^{th} person to login on Friday.

(d) A fourth promotion could give the a person 1000 bonus points for being the one to use the site the most in one month.

(e) A fifth promotion could give $500 cash for only 200 points to the person who refers the most people to myGuide in November.

There are many other such promotions available. Another possible promotion is to offer promotions where a user can earn stock in a company that operates the myGuide website after reaching certain point accumulations. The company can also provide that it is entitled to purchase its own stock using its points.

The present system provides for multiple types of points. The point type defines what a user is able to purchase with their points. Some points are redeemable for cash and some may be redeemed for products and/or services. By controlling the number of each type of point released for distribution and sale one can control long and short term debt.

User's have the option to purchase points. One purpose of purchasing these points is to take advantage of promotions offered by myGuide that could not be taken advantage of otherwise. Purchaser's can enter their credit card or send in a money order and their points would be added to their account.

Providing security against user's attempting to increment their points using automated programmed scripts is an area of concern. Such factors as a user studying user pattern changes and flagging changes which are anomalous provides a basis for monitoring and identifying user patterns. Examples of the latter would be a 50 year old searching for skateboards or a user who uses only email suddenly beginning to use file sharing a great deal.

Upon redemption of any points, pattern identifiers would flag an account if certain criterion were met. Criterion that would be considered in monitoring and identifying user patterns would be age, country, speed, time, software identifiers and user pattern changes. As to age, younger users are generally quicker with their activities justifying more clicks. As to country, if an account is being accessed from Canada and then from China, within a few hours or minutes, the account might be used by more than one person and would not qualify for points. As to time, all transactions are logged with time so we can measure time between actual clicks. Activities happening outside of reasonable time zone patterns might identify the incrementing of points by automated scripts. As to software identifiers, browsers and computers leave identifiers, for example, Internet Explorer would leave its browser type and version number, and a computer would leave many other identifiers. As to user pattern changes, when a user logs in, their normal activities might be to check their inbox or to search the search engine. If points increment on a higher count after a pattern change, a flag would be triggered.

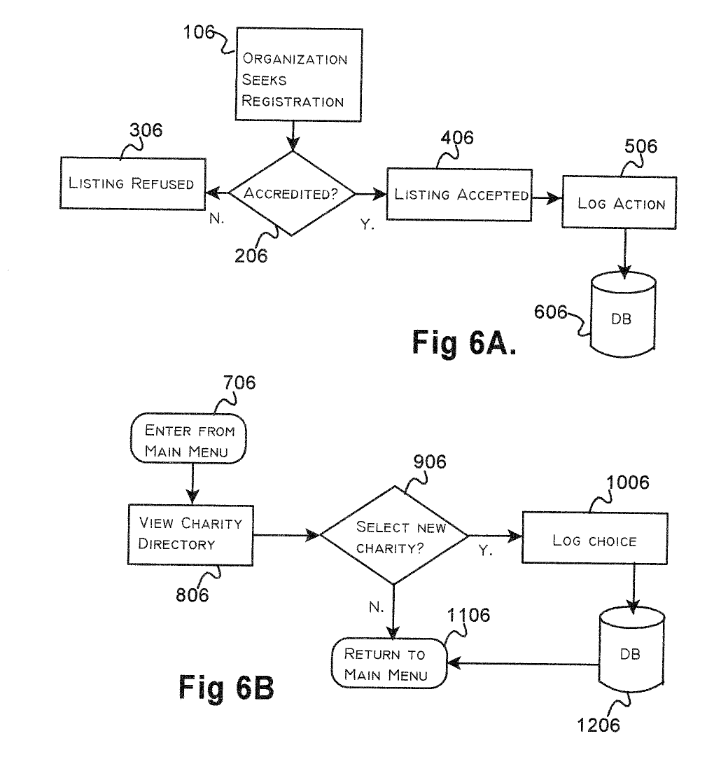

The present system offers free services to charitable organizations and are designed to connect them with donors and volunteers. Users may offer voluntary or monetary donations to these organizations. Charitable organizations can register and apply to be listed amongst other listings in the Charity Directory. The Charity Directory is available to all registered and non-registered users to view and add to their user profiles a Charity of choice to which they can volunteer or donate money. Referring to FIG. 6 an organization at 170 registers with the Charity Directory and at 172 is either accredited or not. If not accredited, then at 174 its listing is not permitted in the Charity Directory. If accredited, at 176 the listing in the Charity Directory is permitted and at 178 the action is logged and the results stored in database 68. A user logs in at 182 and views the Charity Directory at 184. The action is logged at 186 and stored in a database at 68. At 188 a user adds a specific charity to the user's Charity group. This action is logged at 190 and the result stored in the database at 68.

User registration steps are outlined in FIG. 7. At 200 the user visits the website and that action is logged at 202 and the result stored in the database at 68. At 204 the user submits his/her contact information as part of the registration process. The action is logged at 206 and stored in the database at 68. At 208 the user is sent a confirmation email at his/her current email account and the action is logged at 210 and stored in the database at 68. At 212 the user checks on his/her current email account and clicks on the confirmation code. The actions is logged at 214 and stored in the database at 68. At 216 the user is directed to the login page and at 218 again the action is logged and stored in the database at 68. At 220 the user logs in and the action is logged and stored in database at 68. With registration complete, the user is invited to log out at 224. If the user wishes to logout, the action is logged at 226 and stored in the database at 68. If not then no points are awarded and the action is not logged at 228.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description.

1-16. (canceled)

17. A method of awarding incentives to a user of web-based services, said method comprising the steps of:
(a) registering the user as a registered user;
(b) the registered user logging onto a website that provides the web-based services;
(c) providing the registered user with an account for accumulating the incentives acquired by the registered user;
(d) providing the registered user with access to the web-based services once he is logged into the website; and,
(e) incrementing the incentives in the user's account when the registered user accesses the web-based services.

18. The method of claim 17 further comprising the steps of:
(f) the registered user logging out of the website; and,
(g) incrementing the incentives in the account when the registered user performs Step (f).

19. The method of claim 17 further comprising the step of:
(h) incrementing the incentives in the account upon successful completion of Step (a).

20. The method of claim 17 wherein the web-based services include Email services, and wherein the incentives are incremented at Step (e) each time the registered user does at least one of: i) sending an Email; ii) reading an Email; iii) forwarding an Email; and, iv) replying to an Email.

21. The method of claim 20 wherein the incentives are incremented at Step (e) for each new entry the registered user adds to an Email address book using the Email services.

22. The method of claim 17 wherein the web-based services include at least one of: i) a file storage system; and, ii) a file sharing system, and wherein the incentives are incremented at Step (e) each time the registered user does at least one of i) uploading a file, and ii) sharing a file with another registered user.

23. The method of claim 17 wherein the web-based services include a search engine.

24. The method of claim 23 wherein in the incentives are incremented at Step (e) when the registered user does at least one of: i) searching with the search engine; and, ii) clicking on a search result returned by the search engine.

25. The method of claim 17 wherein the incentives are recorded as points.

26. The method of claim 25, further comprising the step of exchanging the points for at least one of: i) cash; ii) merchandise; and, iii) services.

27. The method of claim 25, further comprising the step of awarding the registered user stock in a company, wherein the stock is awarded after a predetermined number of points accumulates in the account of Step (c).

28. The method of claim 27, further comprising the step of redeeming the stock by the company.

29. The method of claim 25 further comprising the step of the registered user purchasing points to be used in Step (e).

30. The method of claim 17, further comprising the step of searching for anomalies in user histories.

31. The method of claim 17, further comprising the step of setting a flag whenever a user's use pattern changes substantially.

32. The method of claim 17, further comprising the step of awarding incentives for logging into the website during at least one of: i) peak hours; and, ii) non-peak hours.

33. The method of claim 17 wherein the web-based services include providing the registered user access to a directory of charities.

34. The method of claim 33 further including the steps of accrediting charities and registering the accredited charities on the directory.

35. The method of claim 17, wherein Step (a) comprises the steps of:
(a1) submitting the user's contact information to the website;
(a2) sending a confirmation email to the user's current email account;
(a3) the user checking the user's current email account, and
(a4) the user clicking on a confirmation code, whereby the user is directed to a log-in page of the website for performing Step (b).

36. The method of claim 17 wherein the web services include web advertising, and wherein the incentives are incremented at Step (e) when the registered user purchases the web advertising.

37. A method of providing incentives to a user of a website, comprising:
(a) the user registering to use the website;
(b) awarding the user incentive points for the user performing Step (a); and,
(c) awarding the user incentive points for the user performing at least one of: i) sending an email; ii) logging onto the website; iii) conducting a search with a search engine; iv) using a file storage and file sharing system; and, v) logging out of the website.

38. A system for providing incentives to a user to use web services, said system comprising:
(a) a registration means for registering the user;
(b) a database for storing the incentives;
(c) a log-in means for logging the user onto the system;
(d) a means for accessing the web services; and,
(e) means for incrementing the incentives stored in the database when the user uses at least one of the web services.

39. A system according to claim 38 wherein the web services include at least one of: i) Email services; ii) file storage services; iii) file sharing services; iv) search engine services; and, v) charity registration and donation services.

40. A system according to claim 38 further including means for incrementing the incentives stored in the database when the user does at least one of: i) logging onto the system; and, ii) logging out of the system.
